(19) United States
(12) Patent Application Publication
(10) Pub. No.: US 2002/0075519 A1
(43) Pub. Date: Jun. 20, 2002

(54) Personal switchboard system and method

(76) Inventors: Shane Konsella, Boise, ID (US); Kwesi E. Abraham, Boise, ID (US); Michael L. Rishel, Boise, ID (US)

Correspondence Address: HEWLETT PACKARD COMPANY, Intellectual Property Adminstration, P.O. Box 272400, Fort Collins, CO, 80527-2400, US

(21) Appl. No.: 09/745,338

(22) Filed: Dec. 20, 2000

(51) Int. Cl. H04N 1/00

(52) U.S. Cl. 358/402; 358/403

(57) ABSTRACT

A system and method for routing a communication originally directed to an original destination to a secondary destination. The original destination and the secondary destination are each one of a voice communication phone number, a fax communication phone number, and an e-mail address. User profile information provided by a user is received and stored. The user profile information identifies the secondary destination. The user profile information includes routing information associating the original destination with the secondary destination. A communication originally directed to the original destination is converted into a format compatible with the identified secondary destination. The converted communication is routed to the secondary destination based on the user profile information.

### THE FIELD OF THE INVENTION

The present invention generally relates to voice and data communications, and more particularly to a personal switchboard for routing communications from multiple input sources and in multiple formats to a customer-configured destination and format.

### BACKGROUND OF THE INVENTION

Currently, there is no complete system for routing communications from multiple input sources and in multiple formats to a customer-configured destination and format. Existing systems and methods include a personal secretary or message service, call forwarding, voice mail systems that can page the receiver for urgent messages, and e-mail systems with auto-forward capabilities. These existing systems and methods have several disadvantages. Problems with a personal secretary include the fact that not everyone has access to a personal secretary, and the use of a personal secretary involves manual processes requiring messages to be dictated, faxes to be manually re-faxed, messages to be retyped, etc. Message services also require similar manual processes. In addition, a secretary or message service may not be available 24 hours a day and seven days a week.

A problem with call forwarding is that it works for “fax-to-fax” and “voice-to-voice” only. Call forwarding does not work with e-mail messages, and does not change formats. Further, call forwarding systems can be difficult to configure because the user interface is a telephone pad.

Problems with voice mail systems that can page the receiver for urgent messages include the fact that such systems only work for “voice-to-voice” communications, and require the user to call back to the voice mail system to obtain messages.

E-mail systems with auto-forward capabilities work for “e-mail-to-e-mail” and some systems work for “e-mail-to-fax” and “e-mail-to-voice,” but these systems do not provide the inverse of these operations, such as “fax-to-e-mail” and “voice-to-e-mail.”

It would be desirable for a system to provide a complete solution to a user's communication needs, including routing communications from multiple input sources and in multiple formats to a customer configured destination and format.

### SUMMARY OF THE INVENTION

The present invention provides a system and method for routing a communication originally directed to an original destination to a secondary destination. The original destination and the secondary destination are each one of a voice communication phone number, a fax communication phone number, and an e-mail address. User profile information provided by a user is received and stored. The user profile information identifies the secondary destination. The user profile information includes routing information associating the original destination with the secondary destination. A communication originally directed to the original destination is converted into a format compatible with the identified secondary destination. The converted communication is routed to the secondary destination based on the user profile information.

### BRIEF DESCRIPTION OF THE DRAWINGS

FIG. 1 illustrates a block diagram of a personal switchboard system according to the present invention.

FIGS. 2A-2C show three operating scenarios in which the personal switchboard system of the present invention is used.

FIG. 3 illustrates contact information assigned to a user for use with the personal switchboard system of the present invention.

FIGS. 4A-4C show three examples of outgoing configuration information for a user for use with the personal switchboard system of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

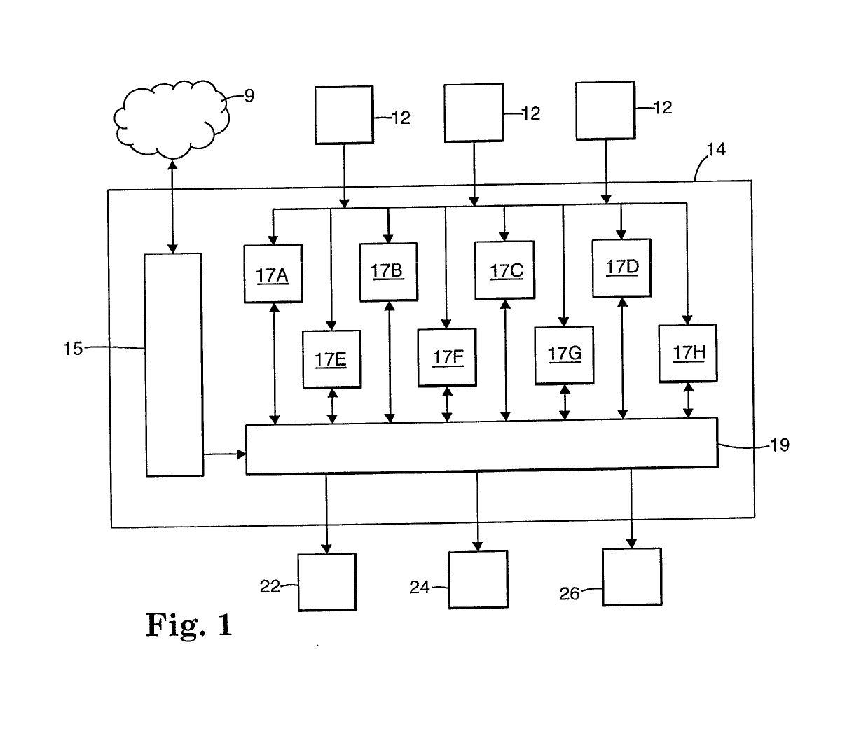

FIG. 1 illustrates personal switchboard system 14 according to the present invention. Personal switchboard system 14 includes numerous subsystems 15, 17A-17H, and 19, that perform a variety of functions. Subsystem 17A receives and sends telephone communications including voice communications, faxes and pages. Subsystem 17B performs “call forward” telephone communications including voice, faxes and pages. Subsystem 17C receives and sends e-mail messages. Subsystem 17D “auto-forwards” e-mail messages. Subsystem 17E converts faxes to digital text (e.g., optical character recognition or OCR). Subsystem 17F converts digital text to voice (e.g., voice synthesis). Subsystem 17G converts digital text into a fax (e.g., fax driver). Subsystem 17H converts voice into digital text (e.g., voice recognition). Internet subsystem 15 allows personal switchboard system 14 to communicate via the Internet. Internet subsystem 15 includes a web-site that allows customers to sign up for the personal switchboard service provided by the present invention, assigns phone numbers and e-mail addresses, and lets users configure their personal switchboard service. Subsystem 19 controls all of the appropriate subsystems 17A-17H based on configuration information provided to subsystem 15.

Software and hardware to perform the above functions are in existence and are commercially available, or are within the abilities of one of ordinary skill in the art to develop. In addition, the above functions performed by personal switchboard 14 may also be implemented in firmware. Each subsystem 15, 17A-17H and 19 includes any necessary memory, including volatile and non-volatile memory. Further, personal switchboard system 14 is shown as a single block in the figures, but may be distributed across multiple locations.

In one embodiment, subsystem 19 includes a storage unit for storing original contact information associated with the user. Subsystem 15 includes a first receiver for receiving secondary contact information from the user. The original contact information and the secondary contact information each include a voice communication phone number, a fax communication phone number, and an e-mail address. Subsystem 15 also includes a second receiver for receiving configuration information from the user. The configuration information associates at least a portion of the original contact information with at least a portion of the secondary contact information. Subsystem 19 includes an identifier identifying a first communication directed to a communication device identified in the original contact information. Subsystem 19 also includes a router for routing a converted communication to the communication device identified in the secondary contact information based on the configuration information. Subsystem 15 includes a transmitter for transmitting via the Internet at least one web page to permit the user to enter the secondary contact information and the configuration information.

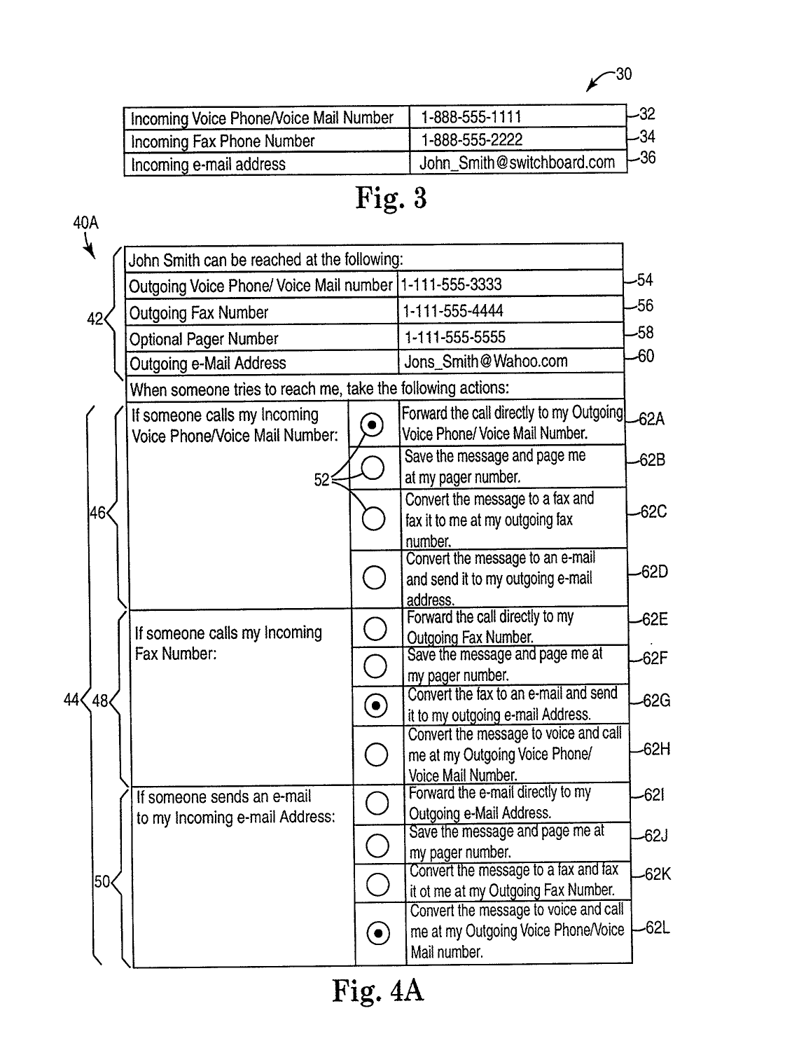

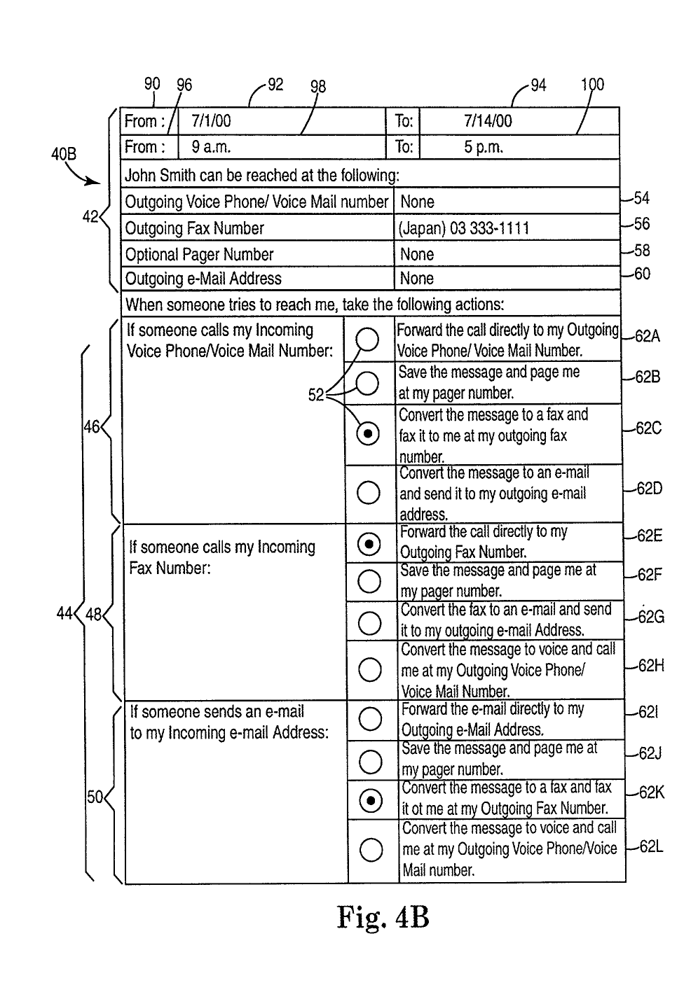

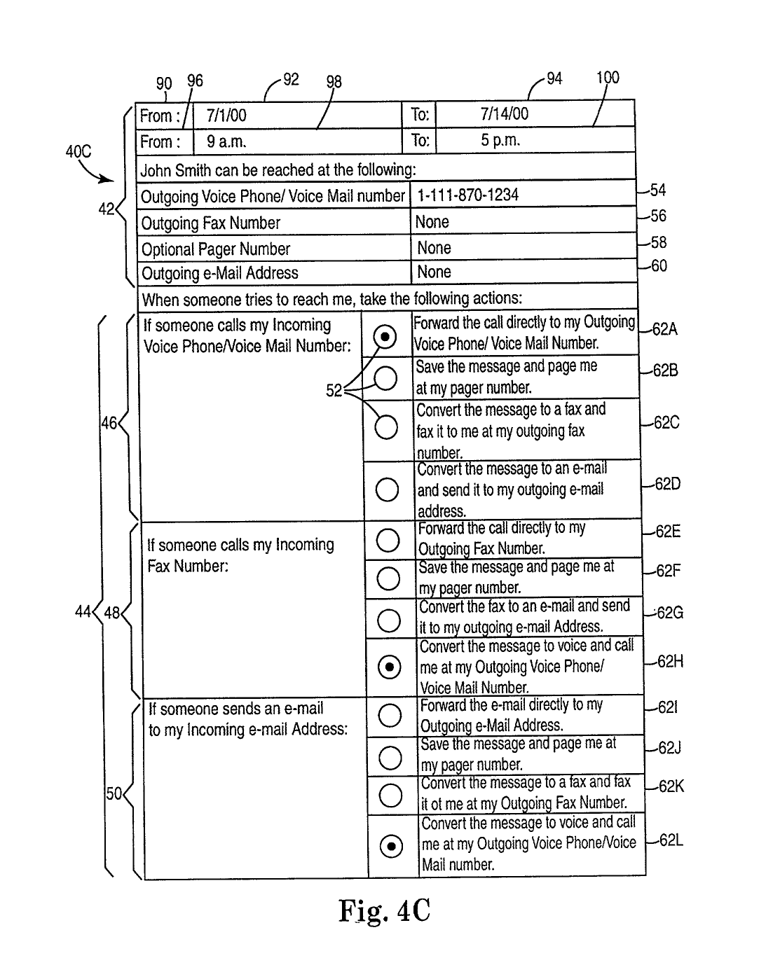

Personal switchboard system 14 routes communications from multiple input sources 12 and in multiple formats to a customer configured set of destinations 22, 24 and 26 and formats. When a user signs up for the service provided by the present invention, the user is assigned contact information (shown in FIG. 3), preferably including an e-mail address, phone number, fax number and pager number, or other contact information, which never needs to change. The user distributes this contact information to friends, colleagues, etc. The user dynamically, and as often as necessary, provides configuration information (shown in FIGS. 4A-4C) to personal switchboard system 14 to route any e-mail, voice message, fax, page, or other communication from an input source 12, to a destination 22, 24 and/or 26, and in a format of the user's choice. In a preferred embodiment, users sign up for the service provided by the present invention and configure their accounts via the Internet 9. Internet subsystem 15 receives the configuration information from a user and passes the information on to subsystem 19, which invokes the appropriate subsystems 17A-17H to perform format conversions and routing based on the configuration information provided by a user.

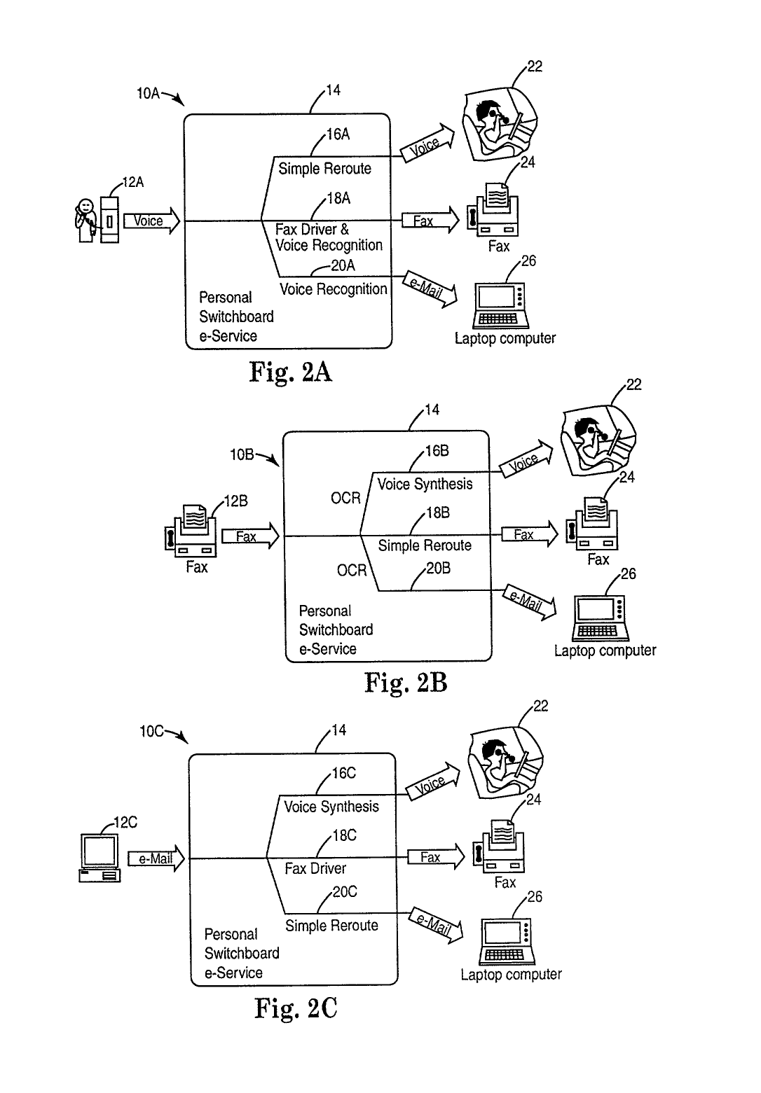

FIGS. 2A-2C illustrate three operating scenarios of personal switchboard system 14 of FIG. 1. FIG. 2A illustrates first operating scenario 10A, wherein personal switchboard 14 receives an input voice communication from input source 12A, and routes a converted communication to voice destination 22, fax destination 24, and e-mail destination 26. In first operating scenario 10A, input source 12A is a telephone that generates a voice communication. Personal switchboard system 14 includes voice line 16A, fax line 18A and e-mail line 20A. Personal switchboard system 14 receives a communication from input source 12A, which in this case is a voice communication, and, based on configuration information entered by a user (shown in FIGS. 4A-4C), routes the communication to one or more of destinations 22, 24 and 26. If the configuration information entered by a user indicates that the incoming communication is to be sent to voice destination 22, personal switchboard system 14 re-routes the voice communication on voice line 16A to voice destination 22. If the configuration information indicates that the incoming communication is to be sent to fax destination 24, personal switchboard system 14 uses voice recognition subsystem 17H and fax driver subsystem 17G to convert the incoming voice communication to a fax document and outputs the fax document on fax line 18A to fax destination 24. If the configuration information entered by a user indicates that the incoming communication is to be sent to e-mail destination 26, personal switchboard system 14 uses voice recognition subsystem 17H to convert the incoming voice communication to an e-mail message and outputs the e-mail message on e-mail line 20A to e-mail destination 26.

FIG. 2B illustrates a second operating scenario, wherein personal switchboard 14 receives an input fax communication from input source 12B, and routes a converted communication to voice destination 22, fax destination 24, and e-mail destination 26. In second operating scenario 10B, input source 12B is a facsimile machine that generates a fax communication. Based on configuration information entered by a user, personal switchboard system 14 routes the incoming fax to one or more of voice destination 22, fax destination 24 and e-mail destination 26. For voice destination 22, personal switchboard system 14 performs optical character recognition (OCR) on the incoming fax with OCR subsystem 17E to convert the incoming fax to a text document, and then performs voice synthesis on the text document with voice synthesis subsystem 17F to generate a voice communication, which is output on voice line 16B to voice destination 22. For fax destination 24, personal switchboard system 14 re-routes the incoming fax communication on fax line 18B to fax destination 24. For e-mail destination 26, personal switchboard system 14 performs OCR on the incoming fax with OCR subsystem 17E to generate a text document, which is output on e-mail line 20B to e-mail destination 26.

FIG. 2C illustrates a third operating scenario, wherein personal switchboard 14 receives an input e-mail communication from input source 12C, and routes a converted communication to voice destination 22, fax destination 24, and e-mail destination 26. In third operating scenario 10C, input source 12C is a computer that generates an e-mail communication. Based on configuration information entered by a user, personal switchboard system 14 routes the incoming e-mail communication to one or more of voice destination 22, fax destination 24 and e-mail destination 26. For voice destination 22, personal switchboard system 14 performs voice synthesis on the incoming e-mail communication with voice synthesis subsystem 17F to generate a voice communication, which is output on voice line 16C to voice destination 22. For fax destination 24, personal switchboard system 14 uses fax driver subsystem 17G to convert the incoming e-mail communication to a fax communication, which is output on fax line 18C to fax destination 24. For e-mail destination 26, personal switchboard system 14 re-routes the incoming e-mail communication on e-mail line 20C to e-mail destination 26.

A user preferably signs up for the “E-service” or personal switchboard service provided by the present invention through the Internet, and is then assigned “incoming” contact information to distribute to friends, colleagues, to print on business cards, etc. FIG. 3 illustrates an example of contact information 30 assigned to a user. Contact information 30 includes an incoming voice phone/voice mail number 32, an incoming fax phone number 34 and an incoming e-mail address 36.

The user configures the E-service by defining the user's default “outgoing” profile. FIG. 4A illustrates an example of an outgoing profile 40A configured by a user, preferably over the Internet via one or more web pages provided by Internet subsystem 15. Outgoing profile 40A includes outgoing configuration information 42, and incoming configuration information 44. Outgoing configuration information 42 includes outgoing voice phone/voice mail number 54, outgoing fax number 56, outgoing pager number 58, and outgoing e-mail address 60. Incoming configuration information 44 includes incoming voice configuration information 46, incoming fax configuration information 48, incoming e-mail configuration information 50, selection buttons 52 and actions 62A-62L (collectively referred to as actions 62). A user enters default outgoing contact information in fields 54, 56, 58 and 60. A user uses selection buttons 52 to select an action 62 that will be taken when the user receives an incoming voice communication on incoming voice phone/voice mail number 32, an incoming fax communication on incoming fax phone number 34 or an incoming e-mail communication at incoming e-mail address 36.

Actions 62A-62D define actions to be taken when someone calls the user's incoming voice phone/voice mail number 32. Action 62A, which is selected in FIG. 4A, forwards the incoming call to the user's outgoing voice phone/voice mail number 54. Action 62B saves the call and pages the user at pager number 58. Action 62C converts the call to a fax and then sends the fax to the user at outgoing fax number 56. Action 62D converts the call to an e-mail communication and sends the e-mail communication to outgoing e-mail address 60.

Actions 62E-62H define actions to be taken when someone calls the user's incoming fax number 34. Action 62E forwards the incoming fax directly to outgoing fax number 56. Action 62F saves the incoming fax and pages the user at pager number 58. Action 62G, which is selected in FIG. 4A, converts the incoming fax to an e-mail communication and sends the e-mail communication to outgoing e-mail address 60. Action 62H converts the incoming fax to a voice communication, and forwards the voice communication to outgoing voice phone/voice mail number 54.

Actions 62I-62L define actions to be taken when someone sends an e-mail to the user's incoming e-mail address 36. Action 62I forwards the incoming e-mail to outgoing e-mail address 60. Action 62J saves the e-mail and pages the user at outgoing pager number 58. Action 62K converts the incoming e-mail to a fax, and then forwards the fax to the user at outgoing fax number 56. Action 62L, which is selected in FIG. 4A, converts the e-mail to a voice communication, and forwards the voice communication to the user at outgoing voice phone/voice mail number 54.

A user may change the user's default outgoing profile 40A at any time through the Internet. FIG. 4B illustrates a modified outgoing profile 40B. Outgoing profile 40B has the same format as outgoing profile 40A shown in FIG. 4A, but also includes date range field 90 and time range field 96. Date range field 90 includes beginning date 92 and ending date 94. Time range field 96 includes beginning time 98 and ending time 100. The user, in this example John Smith, has modified his outgoing profile 40B because of travel plans. Assume that John Smith will be traveling to Japan from 9 a.m. on Jul. 1, 2000 through 5 p.m. on Jul. 14, 2000, will be staying at a hotel, and will not have access to his e-mail. John Smith will not be in his hotel room most of the time, so he cannot rely on being able to receive calls. The hotel has a fax machine for use by its customers, but does not have a voice mail service. Based on this situation, John Smith configures his outgoing profile 40B as shown in FIG. 4B. John Smith enters the time range and date range that he will be gone in time range field 96 and date range field 90. The fax number ((Japan) 03 333-1111) of the hotel that John Smith will be staying at is entered in outgoing configuration information 42 (specifically in outgoing fax number 56), but no other outgoing information is entered.

John Smith then selects actions 62C, 62E and 62K. Action 62C converts an incoming call to a fax and then sends the fax to outgoing fax number 56. Action 62E forwards an incoming fax directly to outgoing fax number 56. Action 62K converts an incoming e-mail to a fax, and then forwards the fax to the user at outgoing fax number 56. Therefore, when John Smith receives a voice communication, a fax document, or an e-mail at the phone numbers or e-mail address listed in his contact information 30, the appropriate conversions are made by personal switchboard system 14 to generate a fax document, which is transmitted to outgoing fax number 56 (the fax number of the hotel John Smith is staying at). John Smith will receive all of his messages while he is in Japan on business, and he need not contact all of his friends, associates, etc.

FIG. 4C illustrates another modified outgoing profile 40C for John Smith. Assume for this example that John Smith will be going on a camping trip from 9 a.m. on Jul. 7, 2000 through 5 p.m. on Jul. 14, 2000, and will be taking only his cell phone, with a phone number of 1-111-870-1234. Again, John Smith enters the date range for his trip in date range field 90, and the time range in time range field 96. John Smith then enters his cell phone number in outgoing voice phone/voice mail number 54.

Finally, John Smith selects actions 62A, 62H and 62L. Action 62A forwards an incoming call to the user's outgoing voice phone/voice mail number 54. Action 62H converts an incoming fax to a voice communication, and forwards the voice communication to outgoing voice phone/voice mail number 54. Action 62L converts an incoming e-mail to a voice communication, and forwards the voice communication to the user at outgoing voice phone/voice mail number 54. Therefore, whether John Smith receives a voice communication, a fax communication or an e-mail at the phone numbers or e-mail address listed in his contact information 30, the appropriate conversions are made by personal switchboard system 14 to generate a voice communication, which is provided to John Smith on his cell phone. Again, John Smith will get all of his messages while he is camping, and he need not contact all of his friends, associates, etc.

The system and method of the present invention provides a complete solution to a user's communication needs. In one embodiment, a set of contact numbers and an e-mail address are assigned to a user. The contact information may be permanently assigned to a user, regardless of whether the user's personal circumstances change that previously required a change in contact information. In one embodiment, the system allows a user to dynamically configure the user's outgoing information using an easy-to-use web interface. All routing and communication format conversions are performed automatically. In one embodiment, the system is always available to the user, allowing the user to receive communications wherever the user wants to receive them, and in a format specified by the user.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of routing a communication originally directed to an original destination to a secondary destination, the original destination and the secondary destination each being one of a voice communication phone number, a fax communication phone number, and an e-mail address, the method comprising:
receiving and storing user profile information provided by a user, the user profile information identifying the secondary destination, the user profile information including routing information associating the original destination with the secondary destination;
converting a communication originally directed to the original destination to a format compatible with the identified secondary destination; and
routing the converted communication to the secondary destination based on the user profile information.

2. The method recited in claim 1, and further comprising transmitting via the Internet at least one web page that provides a means for users to enter the user profile information.

3. The method recited in claim 1, wherein the user profile information is received via the Internet.

4. The method recited in claim 1, wherein the secondary destination includes a pager number.

5. The method recited in claim 1, wherein the converting step includes at least one of the following steps:
synthesizing a voice communication;
performing optical character recognition on a fax communication;
performing voice recognition on a voice communication; and
performing a text-to-fax conversion on an e-mail communication.

6. The method recited in claim 1, wherein the user profile information includes a date range indicating a range of dates for which the user profile information is valid.

7. The method recited in claim 1, wherein the user profile information includes a time range indicating a range of times for which the user profile information is valid.

8. A method of routing communications from multiple input sources in multiple formats to multiple output destinations in multiple formats, the method comprising:
defining an incoming voice phone number, an incoming fax phone number, and an incoming e-mail address;
receiving and storing configuration information identifying an outgoing voice phone number, an outgoing fax phone number, and an outgoing e-mail address;
receiving and storing action information identifying a first action to be performed when a voice communication is directed to the incoming voice phone number, a second action to be performed when a fax communication is directed to the incoming fax phone number, and a third action to be performed when an e-mail communication is directed to the incoming e-mail address; and
performing the first action, second action and third action based on the stored action information and the stored configuration information.

9. The method recited in claim 8, wherein the first action is at least one of forwarding the voice communication to the outgoing voice phone number, converting the voice communication to a fax communication and forwarding the fax communication to the outgoing fax phone number, and converting the voice communication to an e-mail communication and forwarding the e-mail communication to the outgoing e-mail address.

10. The method recited in claim 8, wherein the second action is at least one of converting the fax communication to a voice communication and forwarding the voice communication to the outgoing voice phone number, forwarding the fax communication to the outgoing fax phone number, and converting the fax communication to an e-mail communication and forwarding the e-mail communication to the outgoing e-mail address.

11. The method recited in claim 8, wherein the third action is at least one of converting the e-mail communication to a voice communication and forwarding the voice communication to the outgoing voice phone number, converting the e-mail communication to a fax communication and forwarding the fax communication to the outgoing fax phone number, and forwarding the e-mail communication to the outgoing e-mail address.

12. The method recited in claim 8, and further comprising transmitting via the Internet at least one web page that provides a means for users to enter the configuration information and the action information.

13. The method recited in claim 8, wherein the configuration information and the action information is received via the Internet.

14. The method recited in claim 8, wherein the configuration information includes an outgoing pager number.

15. The method recited in claim 8, and further comprising performing at least one of voice synthesis, optical character recognition, voice recognition, and text-to-fax conversion, on at least one of the voice communication, the fax communication, and the e-mail communication.

16. The method recited in claim 8, and further comprising receiving and storing date range data indicating a range of dates during which the first action, second action, and third action are to be performed.

17. The method recited in claim 8, and further comprising receiving and storing time range data indicating a range of times during which the first action, second action, and third action are to be performed.

18. A personal switchboard system controllable by a user to change contact information of the user on demand, the personal switchboard system comprising:
a storage unit configured to store original contact information associated with the user;
a first receiver configured to receive secondary contact information from the user;
a second receiver configured to receive configuration information from the user, the configuration information associating at least a portion of the original contact information with at least a portion of the secondary contact information;
an identifier configured to identify a first communication directed to a communication device identified in the original contact information;
a converter configured to convert the first communication to a converted communication having a format compatible with a communication device identified in the secondary contact information; and
a router configured to route the converted communication to the communication device identified in the secondary contact information based on the configuration information.

19. The personal switchboard system recited in claim 18, wherein the original contact information and the secondary contact information each include a voice communication phone number, a fax communication phone number, and an e-mail address

20. The personal switchboard system recited in claim 18, and further comprising a transmitter configured to transmit via the Internet at least one web page to permit the user to enter the secondary contact information and the configuration information.

21. The personal switchboard system recited in claim 18, wherein the secondary contact information and the configuration information are received via the Internet.

22. The personal switchboard system recited in claim 19, wherein the secondary contact information includes a pager number.

23. The personal switchboard system recited in claim 18, wherein the converter comprises at least one of a voice synthesis system, an optical character recognition system, a voice recognition system and a text-to-fax conversion system.

24. The personal switchboard system recited in claim 18, wherein the configuration information includes a date range indicating a range of dates for which the configuration information is valid.

25. The personal switchboard system recited in claim 18, wherein the configuration information includes a time range indicating a range of times for which the configuration information is valid.
